(19) United States
(12) Patent Application Publication
(10) Pub. No.: US 2026/0056816 A1
(43) Pub. Date: Feb. 26, 2026

(54) DYNAMIC TIMEOUT WITH REAL-TIME METRICS

(71) Applicant: Dell Products L.P., Round Rock, TX (US)

(72) Inventors: ChihHao HSU, Beitun Dist. (TW); Guan Liang CHEN, Taoyuan City (TW); LiHung YAO, Tainan City (TW)

(73) Assignee: Dell Products L.P., Round Rock, TX (US)

(21) Appl. No.: 18/814,005

(22) Filed: Aug. 23, 2024

(51) Int. Cl. G06F 11/07

(52) U.S. Cl. CPC G06F 11/0757; G06F 11/0721

(57) ABSTRACT

An information handling system may include at least one processor and a memory. The information handling system may be configured to: receive a request to execute an operation, wherein the operation has a default timeout value associated therewith; adjust the default timeout value to a dynamic timeout value different from the default timeout value, wherein the dynamic timeout value is based on one or more metrics regarding a current operational state of the information handling system; and in response to the execution of the operation not completing prior to an expiration of the dynamic timeout value, failing the operation.

### TECHNICAL FIELD

The present disclosure relates in general to information handling systems, and more particularly to improved methods for handling operations that time out.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Various operations executed by an information handling system can take an indeterminate amount of time, which may be based on factors that are generally not known in advance. For example, a function that requests information from network resource might return in milliseconds for a server on the same local area network, seconds for a distant server over a congested link, or never for a malfunctioning server. A computational operation might return in nanoseconds when run on small amount of data, microseconds on a larger amount of data, or never if a programming bug is encountered.

Such operations are often subject to a timeout, which is a determined amount of time beyond which the operation is treated as having failed to prevent indefinitely long execution. The operation may then be abandoned or retried as appropriate.

Traditionally, fixed timeouts have been employed, but these can lead to false timeout triggers due to fluctuating environmental factors. For example, a given operation might naturally take longer during periods of high CPU usage or network latency. Embodiments of this disclosure allow for dynamic adjustment of timeout periods based on real-time system metrics. This allows for more efficient execution of procedures in constantly changing and dynamic environments.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with fixed timeouts may be reduced or eliminated.

In accordance with embodiments of the present disclosure, an information handling system may include at least one processor and a memory. The information handling system may be configured to: receive a request to execute an operation, wherein the operation has a default timeout value associated therewith; adjust the default timeout value to a dynamic timeout value different from the default timeout value, wherein the dynamic timeout value is based on one or more metrics regarding a current operational state of the information handling system; and in response to the execution of the operation not completing prior to an expiration of the dynamic timeout value, failing the operation.

In accordance with these and other embodiments of the present disclosure, a method may include an information handling system receiving a request to execute an operation, wherein the operation has a default timeout value associated therewith; the information handling system adjusting the default timeout value to a dynamic timeout value different from the default timeout value, wherein the dynamic timeout value is based on one or more metrics regarding a current operational state of the information handling system; and in response to the execution of the operation not completing prior to an expiration of the dynamic timeout value, the information handling system failing the operation.

In accordance with these and other embodiments of the present disclosure, an article of manufacture may include a non-transitory, computer-readable medium having computer-executable instructions thereon that are executable by at least one processor of an information handling system for: receiving a request to execute an operation, wherein the operation has a default timeout value associated therewith; adjusting the default timeout value to a dynamic timeout value different from the default timeout value, wherein the dynamic timeout value is based on one or more metrics regarding a current operational state of the information handling system; and in response to the execution of the operation not completing prior to an expiration of the dynamic timeout value, failing the operation.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example method for dynamic timeouts, in accordance with embodiments of the present disclosure.

### DETAILED DESCRIPTION

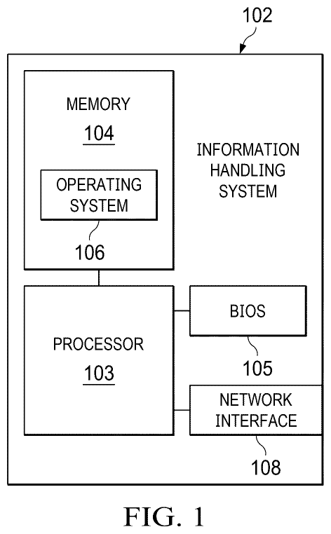

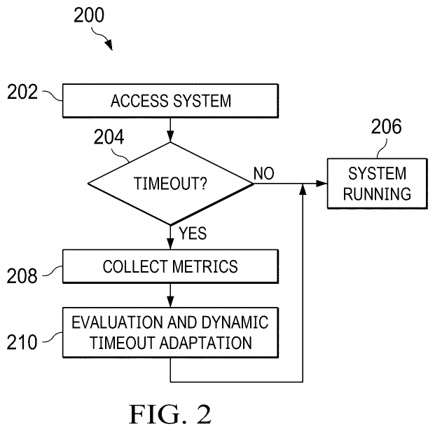

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

As discussed above, information handling system 102 may execute operations that may be subject to a timeout if they take too long. In some cases, the length of the timeout for a given function may be hard-coded into the function or provided as a parameter. In other cases, the function may call out to some other function to determine the appropriate timeout. In yet other cases, different implementation details may be chosen.

Embodiments of this disclosure allow for dynamically adjusting timeout values based on the real-time state of information handling system 102 and/or another information handling system. The state information may include metrics such as CPU usage, memory usage, I/O load, response times, network metrics (latency, packet loss, bandwidth, etc.), database query execution speed, service availability/unavailability, load balancing, etc. In some embodiments, the metrics may be evaluated in real-time, while in other situations historical data may also be used.

In situations where information handling system 102 is a node of an information handling system cluster, the metrics may also include information about other nodes of the cluster, the cluster as a whole, other systems involved in the particular task, etc. For example, for an operation involving a database access, the most important metric might be the current load on the information handling system that hosts the database, etc.

In some embodiments, a given function may be implemented with a default timeout value. This may be the timeout value that is applied when system load is low (e.g., no load, or load below a particular threshold such as 20% utilization of some component). The default timeout value may be scaled up based on one or more real-time system metrics. For example, the default timeout may be scaled up in a continuous fashion by multiplying the default timeout value by a scaling factor. As another example, the default timeout may be scaled up discretely by adding selected amounts of time to the default timeout period as the metrics pass particular thresholds. When the system metrics return to lower levels, the timeouts may then be scaled back down accordingly.

In some instances, multiple functions'timeouts may be scaled up by the same amount defined by a given system load. In other instances, different types of functions may be scaled up by different amounts. For example, the optimal timeout for a compute-bound function may be strongly affected by CPU usage but weakly affected by network usage, and so its scaling may advantageously depend more strongly on CPU usage metrics. The opposite may apply in the case of a network-bound function, etc.

In some implementations, the amount by which timeout values are scaled up may be defined in one or more user-configurable rules. In other implementations, a machine learning model may be trained to determine appropriate scaling values. For example, telemetry data may be collected regarding how long a given function normally takes to run at different system load levels. This data may then be used to train a machine learning model, which may provide appropriate timeout scaling values for the different load levels to distinguish between normal and abnormal operation.

Turning now to FIG. 2, an example method 200 is shown. At step 200, a user may access some functionality of an information handling system. For example, the user might navigate to a web page hosted by the system, access a database hosted on the system, execute some function or operation on the system, etc. At step 204, the system determines whether the user's access has encountered a potential timeout (e.g., by taking longer than the default timeout associated with that operation). If not, the system continues operating normally at step 206.

If so, then the system may determine whether the default timeout should apply, or if some different, dynamically determined timeout should apply. At step 208, the system may collect various system metrics as discussed above. At step 210, the system may determine the dynamic timeout based on the collected metrics. For example, if the system metrics indicate low or no load in the relevant categories, then the system may apply the default timeout. If the load is above a determined threshold, however, the timeout may be scaled up by an amount that is based on the metrics.

The selected timeout may then apply to the operation being accessed. For example, if the operation has taken longer than the selected timeout and has not yet completed, then it may be treated as having failed. The system may then return an error message, retry the operation, etc.

One of ordinary skill in the art with the benefit of this disclosure will understand that the preferred initialization point for the methods depicted in FIG. 2 and the order of the steps comprising that method may depend on the implementation chosen. In these and other embodiments, these method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Accordingly, embodiments of this disclosure may provide improvements in many areas. For example, network resilience may be improved by mitigating network variability effects. When timeouts are adjusted based on latency and packet loss, excessive retransmission of packets may be reduced, ensuring functionality in challenging network conditions. The user experience may be improved as well, by providing a more responsive application or service. Overall adaptability of the system may be improved by enabling automatic adjustments to timeout periods as systems evolve, making applications more responsive to changing needs. Further, embodiments may reduce the number of false alarms and unnecessary retries generally.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or System being adapted to, arranged to, Capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
at least one processor; and
a memory;
wherein the information handling system is configured to:
receive a request to execute an operation, wherein the operation has a default timeout value associated therewith;
adjust the default timeout value to a dynamic timeout value different from the default timeout value, wherein the dynamic timeout value is based on an output of a trained machine learning model applied to one or more metrics regarding a current operational state of the information handling system; and
in response to execution of the operation not completing prior to an expiration of the dynamic timeout value, failing the operation.

2. The information handling system of claim 1, wherein failing the operation comprises retrying the operation.

3. The information handling system of claim 1, wherein the dynamic timeout value is the default timeout value multiplied by a scaling factor, and wherein the scaling factor is determined based at least in part on the one or more metrics.

4. The information handling system of claim 1, wherein the one or more metrics include at least one metric selected from the group consisting of processor usage, memory usage, and network usage.

5. The information handling system of claim 1, wherein the dynamic timeout value is further based on one or more other metrics regarding a current operational state of another information handling system.

6. The information handling system of claim 1, wherein the dynamic timeout value is further based a historical operational state of the information handling system.

7. A method comprising:
an information handling system receiving a request to execute an operation, wherein the operation has a default timeout value associated therewith;
the information handling system adjusting the default timeout value to a dynamic timeout value different from the default timeout value, wherein the dynamic timeout value is based on an output of a trained machine learning model applied to one or more metrics regarding a current operational state of the information handling system; and
in response to execution of the operation not completing prior to an expiration of the dynamic timeout value, the information handling system failing the operation.

8. The method of claim 7, wherein failing the operation comprises retrying the operation.

9. The method of claim 7, wherein the dynamic timeout value is the default timeout value multiplied by a scaling factor, and wherein the scaling factor is determined based at least in part on the one or more metrics.

10. The method of claim 7, wherein the one or more metrics include at least one metric selected from the group consisting of processor usage, memory usage, and network usage.

11. The method of claim 7, wherein the dynamic timeout value is further based on one or more other metrics regarding a current operational state of another information handling system.

12. The method of claim 7, wherein the dynamic timeout value is further based a historical operational state of the information handling system.

13. An article of manufacture comprising a non-transitory, computer-readable medium having computer-executable instructions thereon that are executable by at least one processor of an information handling system for:
receiving a request to execute an operation, wherein the operation has a default timeout value associated therewith;
adjusting the default timeout value to a dynamic timeout value different from the default timeout value, wherein the dynamic timeout value is based on an output of a trained machine learning model applied to one or more metrics regarding a current operational state of the information handling system; and
in response to execution of the operation not completing prior to an expiration of the dynamic timeout value, failing the operation.

14. The article of claim 13, wherein failing the operation comprises retrying the operation.

15. The article of claim 13, wherein the dynamic timeout value is the default timeout value multiplied by a scaling factor, and wherein the scaling factor is determined based at least in part on the one or more metrics.

16. The article of claim 13, wherein the one or more metrics include at least one metric selected from the group consisting of processor usage, memory usage, and network usage.

17. The article of claim 13, wherein the dynamic timeout value is further based on one or more other metrics regarding a current operational state of another information handling system.

18. The article of claim 13, wherein the dynamic timeout value is further based a historical operational state of the information handling system.
